(19) United States
(12) Patent Application Publication
(10) Pub. No.: US 2012/0233473 A1
(43) Pub. Date: Sep. 13, 2012

(54) Power Management in Networks

(75) Inventors: Jean-Philippe Vasseur, Saint Martin d'Uriage (FR); Yegnanarayanan Chandramouli, Bangalore (IN); Stefano Previdi, Rome (IT); Aravind Sitaraman, Bangalore (IN)

(73) Assignee: CISCO TECHNOLOGY, INC., San Jose, CA (US)

(21) Appl. No.: 13/043,169

(22) Filed: Mar. 8, 2011

(51) Int. Cl. G06F 1/00; G06F 15/173

(52) U.S. Cl. 713/300; 709/223

(57) ABSTRACT

In one implementation, the power consumption by network devices may be managed by accessing a routing protocol that manages an allocation of processing resources in a network. The routing protocol may be used for generating a first configuration, for which a utilization of resources may be determined. A first cost for the first configuration may be determined. A second configuration may be identified to support the utilization of the resources. A second cost may be determined for the second configuration. The first cost may be compared to the second cost. The prospective performance of the network for the second configuration may be assessed. Based on the results of the comparison and the assessment, the network may be configured to use the second configuration. Processing resources may be activated on inactive network devices to support the second configuration and deactivated on active network devices that are not utilized in the second configuration.

### TECHNICAL FIELD

The following disclosure relates generally to power management in networks.

### BACKGROUND

The devices in a network utilize various resources for their operation that require energy expenditure. For example, organizations may use multiple data centers to support complex and competing demands. Servers and routers in a data center may have significant power consumption.

### BRIEF DESCRIPTION OF THE FIGURES

FIG. 1 illustrates an example of a communications system that enables power management of network devices using resource utilization measurements and routing decisions.

FIG. 2 illustrates an example of resource utilization data collected from multiple network devices in a network.

FIG. 3 illustrates an example of a system that is used computing network policies for power management in a network.

FIG. 4 illustrates an example of a system for processing traffic that is managed for energy savings in a network.

FIG. 5 is a flow chart illustrating an example of a process for implementing power management in a network.

### DESCRIPTION OF EXAMPLE EMBODIMENTS

### Overview

An organization manages power consumption by devices in a network through the use of a routing protocol that manages an allocation of processing resources in the network. The routing protocol may be used for generating a first configuration. For the first configuration, a utilization of resources in the network is determined. For example, an organization responding to Internet queries may determine that a particular processing load at a particular time is a specified level (e.g., one million requests per second that require 100 million processing operations per second that can be performed by 5 million processors running an application). Based on the determined utilization of resources in the first configuration, a first cost is determined that is indicative of the power consumption of network devices associated with the first configuration. If a first data center is used, an organization, e.g., a service provider, may determine that operating 5 million processors at location X requires Y kilowatts of power that cost a first dollar amount per hour.

A second configuration that is different from the first configuration is identified to support the determined utilization of the resources in the network. For example, the organization may determine the cost of supporting the processing requirement out of a data center where the cost of electricity may be less. In some markets, electricity is priced based on demand, time of day, relative to peak demand and/or relative to a specified power consumption budget. Thus, the ability to transfer processing demand to a location with processing capacity available at a lower cost may be used to realize cost savings. Moreover, a second cost that is indicative of power consumption of network devices associated with the second configuration may be determined, to enable comparison of the first cost with the second cost. The prospective performance of the network, assuming the second configuration was adopted, may be assessed. For example, the organization may perform simulation studies to determine whether the processing load at a given time can be satisfied by the second configuration. The simulation studies may be performed in real time by a network device. Based on the result of the comparison of the first cost to the second cost and the result of the assessment of the prospective network performance, a decision may be made to adopt the second configuration. This may result in the organization dynamically transferring subsequent requests and/or existing tasks from a first data center to a second data center.

Based on the decision to adopt the second configuration, the network may be configured to use the second configuration. The second configuration may be implemented using a routing protocol that routes requests to a different location and/or configures network equipment to selectively activate processors. Processors may be activated selectively on inactive network devices to support the second configuration and processors may be deactivated on active network devices that are used in the first configuration but that are not utilized in the second configuration.

In another implementation, resource utilization of network devices in a network may be managed. Managing utilization may be achieved by assessing a resource utilization characteristic of an existing network configuration and assessing a resource utilization characteristic that is anticipated for a prospective network configuration if the prospective network configuration were adopted. Thereafter, the assessed resource utilization characteristic of the existing network configuration may be compared to the assessed/anticipated resource utilization characteristic of the prospective network configuration. A performance characteristic of the prospective network configuration may be assessed. The prospective network configuration may be adopted only if the comparison of the resource utilization characteristic and assessment of the performance characteristic yield results indicating that the resource utilization and performance would be improved upon adopting the prospective network configuration.

### DETAILED DESCRIPTION OF EXAMPLE EMBODIMENTS

Network devices utilize multiple different resources in order to process data and to route traffic. The utilization of resources requires energy expenditure which may result in significant power consumption by the network, for example when a large number of network devices are accessing resources for data processing and traffic routing. Processes may be implemented in a network for power management, with a goal of saving energy and/or reducing costs, among other goals.

A key challenge in power management in a network is determining appropriate rules and policies according to which various network devices may be turned on or turned off depending on usage. Power management may be efficiently achieved by adopting a system level approach. For a network device, the power consumption state (e.g., sleep or hibernate or shutdown) is orchestrated based on the analysis of that network device's resource utilization over specific periods of time, for example time-of-day, in conjunction with analysis of traffic patterns in the network and information on the network topology. Such a system level approach facilitates efficient power management in a network where the traffic patterns may change over time.

For each network device that is considered for power management, measurements related to resource utilization of the network device may be collected and stored in a centralized controller node (which may be hosted as a software component on a networking device). For example, CPU (central processing unit) capacity of the network device, link load, and percentage utilization of the CPU by the network device illustrate examples of measurements, and the centralized controller node illustrates an exemplary networked computer that runs software processes used for power management, with measurements collected and stored in the centralized node characterized by time periods. The time period used is selected to accommodate traffic patterns during a specific period of time in a day, or on specific days of a week, or other similar heuristics. For example, time period used may be time-of-day or day-of-week.

Historical data on the network performance and the performance of various network devices also may be accessible in the controller node. Based on the resource utilization measurements and the historical data, the controller node may compute traffic patterns and resource requirements of each application for a specific time period, for example, time-of-day. For the computed resource requirements, network policies for the specified time periods may be derived by the controller node. The network policies may determine which network devices to use and which network devices to deactivate in a given time period so that the energy savings requirements are satisfied.

In addition to the resource utilization measurements, SLAs (service level agreements) and performance or reliability objectives of applications supported by the network also may be specified in the centralized node. The SLAs are taken into account by the controller node before affecting any change in the network for the network policies. An instance of a routing protocol may be operational in the controller node. The routing protocol may be similar to the routing protocol that is used to route traffic among the network devices in the network. However, the instance running in the controller node may not be actively engaged in routing traffic through the controller node. Instead, it may be operational to enable the controller node to gather information on the network topology and the routing fabric. The controller node may use this information on network topology to analyze the impact on the traffic routing in the network that would happen if the controller node deactivated network devices based on the network policies that are derived for power management. For example, the controller node may trigger an SPF (shortest path first) routing update by removing a network device (e.g., a processor responding to queries) that is considered for hibernation based on the derived network policies. The controller may analyze whether the updated routing topology is capable of supporting SLAs for critical traffic, and whether there are redundant paths in the network to handle link or node failure.

Based on the analysis of the effect of network policies for power management on the routing traffic, the controller node may determine to activate some network devices and deactivate some other network devices. Accordingly, the processes running in the controller node that are used for power management may communicate the derived network policies to corresponding processes used for power management running on each network device that is to be activated. The processes used for power management in a network device may communicate the received network policies to hardware interfaces in the network device that are used for power management. Based on the network policies, the hardware interfaces may be configured on an inactive network device so that it is operational in the network. Once all the inactive network devices that are to be activated are operational, the controller node may determine whether the network traffic is being routed correctly through the network devices that are to be used based on the network policies. If the controller node is satisfied that the network traffic is being routed correctly, it may communicate the derived network policies to power management processes on each network device that is to be deactivated. Consequently, the hardware interfaces may be configured to set the power levels on each network device such that the network device is deactivated by entering a sleep state or hibernation state or by shutting down.

In addition or as an alternative to communicating with network devices that are used for power management, the controller node may communicate the resource requirements and network policies for the specified time periods to a load balancer in the network. The load balancer may include a computing device that manages the allocation of traffic flows among the network devices. Based on the information provided, the load balancer may adjust its parameters to such that the load is distributed among network devices that are activated based on the network policies.

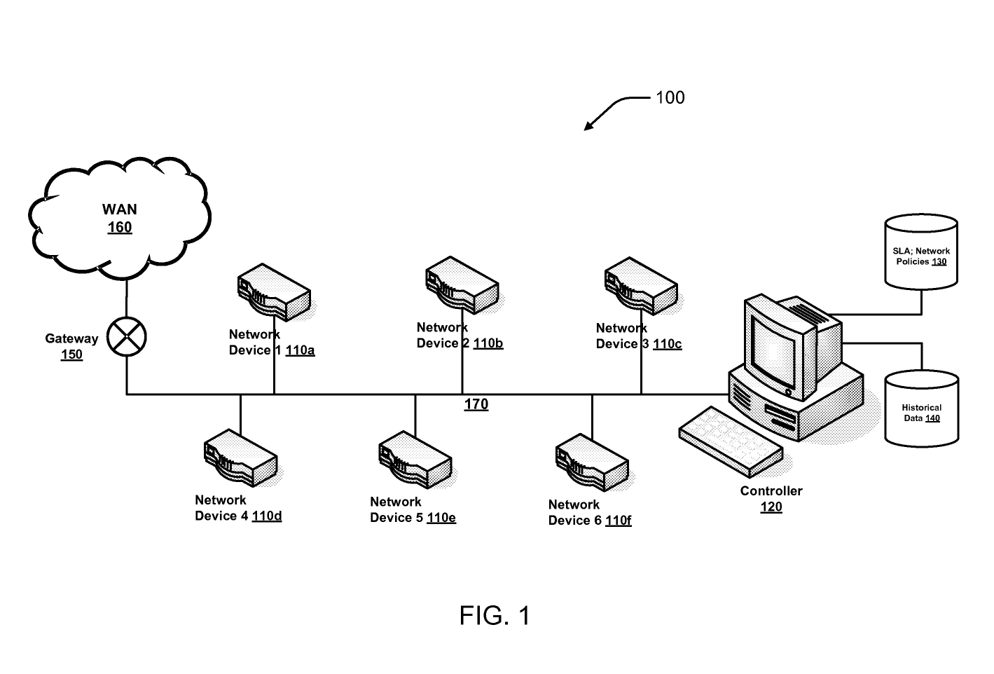

FIG. 1 illustrates an example of a communications system 100 that enables power management of network devices using resource utilization measurements and routing decisions. Communications system 100 includes one or more network devices 110a, 110b, 110c, 110d, 110e and 110f that are connected to one another and to a controller 120 via a LAN (local area network) 170. The controller 120 is connected to a database 130 that includes SLAs and network policies, and to a database 140 that includes historical data regarding communications system 100. The network devices 110a, 110b, 110c, 110d, 110e and 110f and controller 120 are connected to a WAN (wide area network) 160 through a router or gateway 150.

Communications systems 100 may represent a network for routing and processing data traffic. For example, communications system 100 may represent a data center network comprising network devices of various types. The network devices 110a, 110b, 110c, 110d, 110e and 110f may include routers, switches, load balancers, firewalls and enterprise servers or any combination thereof or any other type. In another example, communications system 100 may include a central office network, with network devices 110a, 110b, 110c, 110d, 110e and 110f comprising routers, switches, load balancers and firewalls or any combination thereof or any other type. As another example, communications system 100 may represent an engineering laboratory network in which the network devices 110a, 110b, 110c, 110d, 110e and 110f include routers and switches or any combination thereof or any other type. Any of the communications system 100 exemplified here may implement a system level approach to power management of the network devices.

The network devices 110a, 110b, 110c, 110d, 110e and 110f may include computing devices that are used to process and route data traffic. For example, as described previously, one or more of network devices 110a, 110b, 110c, 110d, 110e and 110f may represent a router that is used to route traffic from a source to a destination by routing table lookup. One or more of network devices 110a, 110b, 110c, 110d, 110e and 110f also may include an enterprise server or device running an enterprise application that is used for processing data traffic. The network devices 110a, 110b, 110c, 110d, 110e and 110f may execute one or more instructions or processes on one or more processors within the network devices. The executed instructions or processes may enable power management on the network devices 110a, 110b, 110c, 110d, 110e and 110f by communicating with power management processes running on the controller 120, and also with hardware processes running on internally on the network devices 110a, 110b, 110c, 110d, 110e and 110f.

The controller 120 may represent a general purpose computing device that enables power management of network devices in communications system 100. For example, controller 120 may include a computer with one or more processors and one or more pieces of memory. Controller 120 may have a display device, for example a monitor, connected to it for displaying information to a human user. Controller 120 also may have one or more I/O (input/output) devices, for example a keyboard and a mouse, connected to it for enabling interaction with a human user. The controller 120 may include one or more instructions or processes that are generally stored in memory in the controller 120 and are executed using the one or more processors in the controller 120. The one or more instructions or processes may enable the controller 120 to collect and store data of resource utilization from the network devices 110a, 110b, 110c, 110d, 110e and 110f. The resource utilization data may be stored in memory in the controller 120, or in an external database that is accessible by the resource controller 120. The one or more instructions or processes also may enable the controller 120 to compute measurements on the resource utilization data and determine network policies. In order to compute measurements on the resource utilization data and determine network policies, the instructions or processes may access SLAs and other network policy information from a database 130 that is connected to the controller 120, and historical data and trends from a second database 140 that is connected to the controller 120.

The controller 120 may be configured to develop, manage, and analyze the historical data and trends that are related to the performance of the network devices over specific time periods. The historical data and trends also may be related to the traffic that is processed and/or routed in the communications system 100 using the network devices 110a, 110b, 110c, 110d, 110e and 110f In one implementation, the database 130 and the database 140 may represent the same database that includes the SLAs, information related to network policies and the historical data and trends. In another implementation, the database 130 and the database 140 may be located in the memory in controller 120.

The gateway 150 may control the flow of traffic between the communications system 100 and external networks. In one implementation, gateway 150 may represent a border router running a gateway routing protocol to connect the communications system 100 with a WAN 160. The WAN 160 may comprise one or more networks, for example, the Internet and LANs that may be similar to communications system 100.

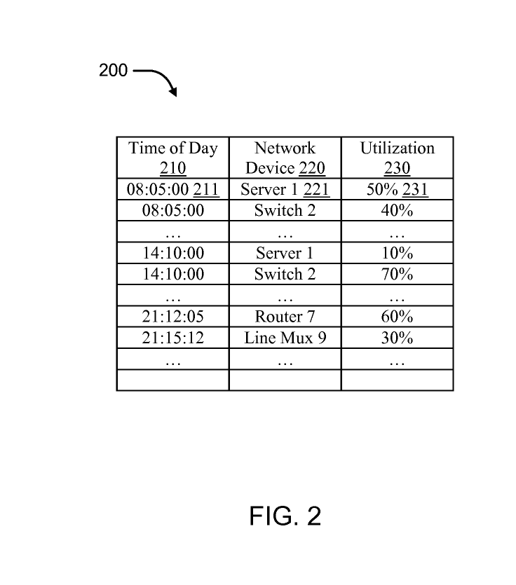

FIG. 2 illustrates an example of resource utilization data 200 collected from multiple network devices in a network. The resource utilization data 200 may include information on the time of day 210 when data is collected, the network device 220 from which the data is collected and the utilization data 230 that is collected.

In the example shown in FIG. 2, the network may represent the communications system 100 and the network devices may represent 110a, 110b, 110c, 110d, 110e and 110f that are described with reference to FIG. 1. The resource utilization data 200 may be stored in controller 120. In a network device 220, the resource utilization data 230 may be collected by one or more instructions or processes that are running on the network device and are used for power management on the network device. The instructions or processes that are used for power management on a network device may transmit the collected resource utilization data 230 to the controller 120 over the LAN 170.

The resource utilization data 200 collected from the network devices may be used by the controller for measurements on resource utilization and to determine network policies based on the analysis of the measurements. For example, data may be collected at 08:05:00 hours 211 for server 1 221 showing 50% utilization 231. The server 1 221 may represent the network devices 110a, 110b, 110c, 110d, 110e and 110f. The resource utilization 231 may represent the percentage utilization of CPU capacity of server 1 221 at 08:05:00 hours 211. As an alternative, the resource utilization 231 may represent the percentage link level utilization of a link that is connected to a specified port on server 1 221 at 08:05:00 hours 211.

In another implementation, the resource utilization data may be collected for day of the week, in addition to or instead of, time of day. The resource for which the utilization data 230 is collected from a network device 220 may be represented as power consumption per server, CPU capacity/utilization, memory utilization, disk utilization, traffic utilization in terms of packets per second, link capacity, link utilization, interface capacity and interface utilization. In addition to the data collected for the resources, measurements may be collected for one or more environmental parameters.

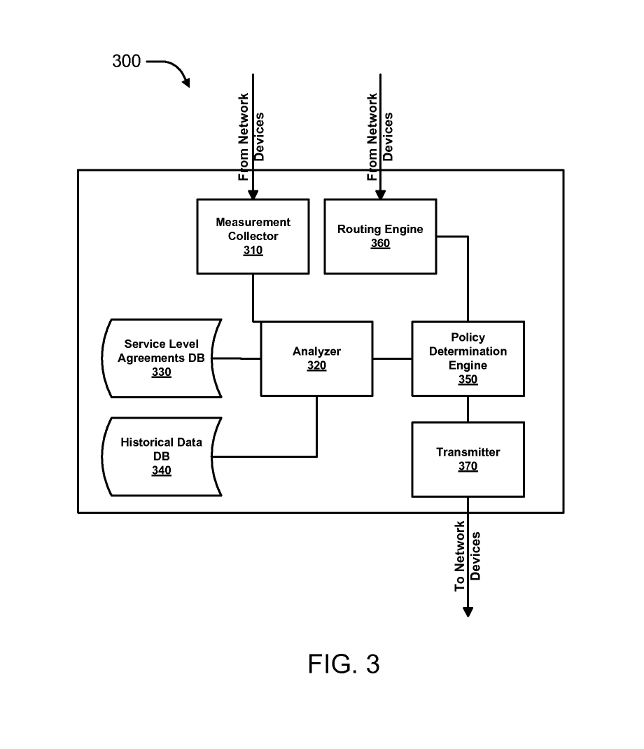

FIG. 3 illustrates an example of a system 300 that is used computing network policies for power management in a network. The system 300 may be implemented, for example, using the controller 120 in communications system 100. System 300 comprises a measurement collector 310 that is connected to an analyzer 320. The analyzer 320 receives inputs from a service level agreements database 330 and a historical data database 340. The output of the analyzer is sent to a policy determination engine 350. The policy determination engine 360 also receives input from a routing engine 360 and sends its output to a transmitter 370 is that connected to network devices.

The measurement collector 310 may comprise one or more processes that receive resource utilization data from network devices in the network. For example, measurement collector 310 may be processes running in the controller 120 that receive resource utilization data from network devices 110a, 110b, 110c, 110d, 110e and 110f in communications system 100. Measurement collector 310 may process the resource utilization data and generate measurements on the processed data, for example in the form of resource utilization data 200 that is described with reference to FIG. 2. Measurement collector 310 may characterize the measurements by specific time periods, for example time-of-day or day-of-week. The collected data and measurements may be accessed by the analyzer 320.

The analyzer 320 may comprise one or more processes that are used to determine resource requirements for applications running in the network. For example, analyzer 320 may represent processes running in the controller 120 that access the resource utilization measurements from the measurement collector 310. Analyzer 320 also may access SLAs for the applications from a service level agreements database 330, and historical data and trends from a historical data trends database 330. Based on the analysis of the SLAs and the resource utilization measurements, the analyzer 320 may compute resource requirements for each application for a specific time period, for example, time-of-day. The analyzer 320 may use deterministic algorithms for the analysis of the resource utilization measurements. In an alternative implementation, the analyzer 320 may use predictive algorithms based on the historical data and trends for the analysis of the resource utilization measurements. Based on the analysis of the resource utilization measurements, the analyzer 320 may infer the traffic patterns and trends in the network and power consumption patterns of the network devices. The analysis of the resource utilization measurements and the computed application resource requirements may be transmitted by the analyzer 320 to the policy determination engine 350.

The policy determination engine 350 may comprise one or more processes that are used to determine network policies to be implemented in the network for power management. For example, policy determination engine 350 may include one or more processes running in the controller 120 that access the analysis of resource utilization measurements and computed resource requirements from the analyzer 320. Policy determination engine 350 also may access information on the network topology from a routing engine 360 that is operational in the system 300. Based on the information from the analyzer 320 and the routing engine 360, policy determination engine 350 may compute the network policies for power management. The computed network policies may dictate that one or more network devices that are presently operational be deactivated and one or more other network devices that are presently inactive be activated. Based on the computed network policies, policy determination engine 350 communicates with the routing engine 360 to determine whether SLAs for the applications and network reliability can be satisfied upon implementing the computed network policies. If it is determined that the SLAs and network reliability can be satisfied, policy determination engine 350 sends the computed network policies to the transmitter 370.

The routing engine 360 may comprise one or more processes that are used to configure the routing fabric and network topology in the network. For example, routing engine 360 may comprise an instance of a routing protocol that runs in the controller 120 in communications system 100. The routing protocol may include the same protocol instances of which run on the network devices 110a, 110b, 110c, 110d, 110e and 110f and is used for routing traffic in the communications system 100. The routing engine 360 enables the system 300 to be incorporated within the routing domain in the network and thus collect information on the network topology. Routing engine 360 may collect information on the network topology without routing any traffic itself For example, this may be achieved by setting the value to binary “1” for a specific bit in a hardware register of the system 300, which allows the routing engine to be a passive observer in the routing domain in the network to learn the routing domain without receiving data packets from network devices in the network or without being used as a switch or router. Alternatively, the routing engine 360 may represent a device incorporated within an active router, load balancer, or other active traffic forwarding device. The information on the routing domain and network topology determined by the routing engine 360 may be accessed by the policy determination engine 350.

The routing engine 360 also may be used by the policy determination engine 350 to determine impact of implementing network policies computed by the policy determination engine. For example, based on instructions received from the policy determination engine 350, the routing engine 360 may compute an SPF update to the routing fabric in the network after removing a presently-active network device that is considered for deactivation by the policy determination engine 350 based on the computed network policies. In case of a network that implements MPLS (Multiprotocol Label Switching) Traffic Engineering, the routing engine 360 may compute a CSPF (constrained shortest path first) update to the routing fabric in the network, where the constraint may represent minimum bandwidth required per link, end-to-end delay, or the maximum number of links traversed. The routing engine 360 takes into account the network utilization while performing the SPF computation and may use one or more pre-determined algorithms to infer the routing fabric based on the network utilization. The routing engine 360 may perform a second order optimization to ensure that there are redundant paths in the network to satisfy network reliability and SLAs for important applications are satisfied in the event that a link or node fails in the network when the computed network policies are implemented. The routing engine 360 transmits the results of the SPF computation and the second order optimization to the policy determination engine 350. If it is determined that the SLAs and network reliability can be satisfied, policy determination engine 350 sends the computed network policies to the transmitter 370.

The transmitter 370 may comprise one or more processes and one or more hardware interfaces for communicating information to network devices in the network. For example, the transmitter 370 may include one or more network ports and associated logic in the controller 120 that are connected through the LAN 170 to the network 110a, 110b, 110c, 110d, 110e and 110f in the communications system 100. Based upon instructions received from the policy determination engine 350, the transmitter 370 may transmit the network policies to processes in one or more inactive network devices. The inactive network devices may be activated upon receiving the network policies from the transmitter 370. The policy determination engine 350 may co-ordinate with the routing engine 360 to determine whether the traffic is flowing correctly in the network due to the newly activated devices and whether network reliability and SLAs for important applications are satisfied. The policy determination engine 350 in coordination with the routing engine 360 may determine that the traffic flow is correct with the newly activated devices and that the network reliability and SLAs for important applications are satisfied. Based upon this determination, the policy determination engine may further instruct the transmitter 370 to transmit the network policies to one or more active network devices. The active network devices may be deactivated upon receiving the network policies from the transmitter 370, for example by entering sleep state or hibernation state or by shutting down.

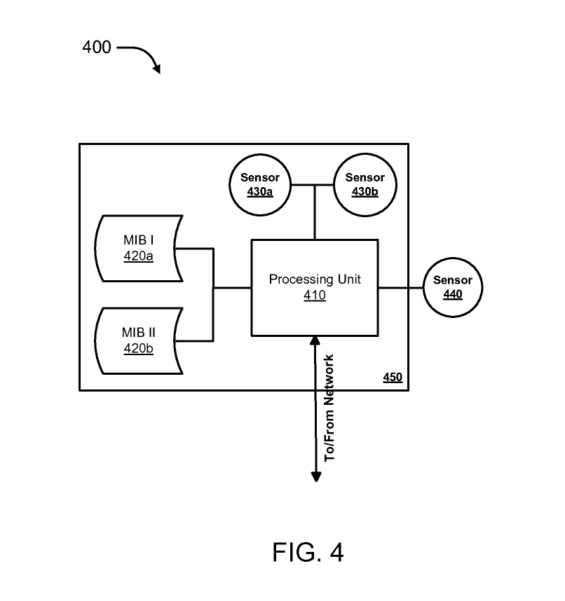

FIG. 4 illustrates an example of a system 400 for processing traffic that is managed for energy savings in a network. The system 400 may be implemented, for example, in any of the network devices 110a, 110b, 110c, 110d, 110e and 110f in communications system 100. System 400 comprises a processing unit 410 that is connected to a MIB (Management Information Base) I 420a and a MIB II 420b. Processing unit 410 is also connected to sensors 430a and 430b that are embedded on the system 400. In addition, a sensor 440 that is external to the physical enclosure 450 is connected to the processing unit 410. The processing unit 410 also may communicate with other devices in the network through one or more network interfaces.

The processing unit 410 may comprise one or more processors and one or more routing engines. The processing unit 410 may be used to process data traffic and route data traffic. For example, processing unit 410 may include the CPU in a router in a network. Alternatively, processing unit 410 may include the CPU in a server in a network. One or more processors in the processing unit 410 may take part in power management, in association with other devices in the network. Processing unit 410 may be used to collect data related to utilization of resources in the network by the system 400. The resources may include power consumption by the system 400, processing capacity of processing unit 410, percentage utilization of processing capacity of processing unit 410, memory utilization by system 400, disk utilization by system 400, traffic utilization in terms of packets per second, link capacity of the link connecting system 400 to the network, link utilization of the link connecting system 400 to the network, interface capacity of an interface on the system 400 that is used for connecting to the network and utilization of the said interface.

In addition to the utilization data collected for the resources, processing unit 410 also may collect measurements for one or more environmental parameters that affect the performance of system 400. To collect measurements for the one or more environmental parameters, processing unit 410 may access MIB I 420a and MIB II 420b. MIB I 420a and MIB II 420b may include information related to one or more parameters of the system 400 that may be managed by an instance of a network management protocol, for example SNMP (Simple Network Management Protocol) or CoAP (Constrained Application Protocol) that is running on processing unit 410. MIB I 420a and MIB II 420b may be stored in memory in the system 400.

Processing unit 410 also may access data collected by sensors 430a, 430b and 440. The sensors may “sense” one or more ambient parameters (e.g., temperature and humidity) that affect the system 400. Based on the data collected by network management instance using MIB I 420a and MIB II 420b and also the ambient parameters sensed by the sensors, the processing unit 410 may collect measurements for one or more environmental parameters. The environmental parameters may include physical location of the system 400 (e.g., location of a server or a router that is an instance of system 400 in a row or rack in a data center), ambient temperature of the system 400 (e.g., temperature of the rack in which a server is located), humidity (e.g., humidity in the rack in which a server is located) and heat dissipation (e.g., heat dissipation due to the operation of the various hardware components of the system 400). Measurements of other environmental parameters also may be collected.

The resource utilization data and the environmental parameters measurements that are collected by the processing unit 410 may be sent by the processing unit 410 to a central location over the communications link that connects the system 400 to the network. For example, the central location may include the controller 120 described with reference to FIG. 1 that is used as the controller node for power management. The resource utilization (e.g. link capacity, link utilization, interface capacity, interface utilization, power consumption per server, CPU capacity/utilization, memory utilization or disk utilization) data and the environmental parameters measurements that are sent from the system 400 may be used by the controller node in determining network policies for power management in the network where system 400 is located.

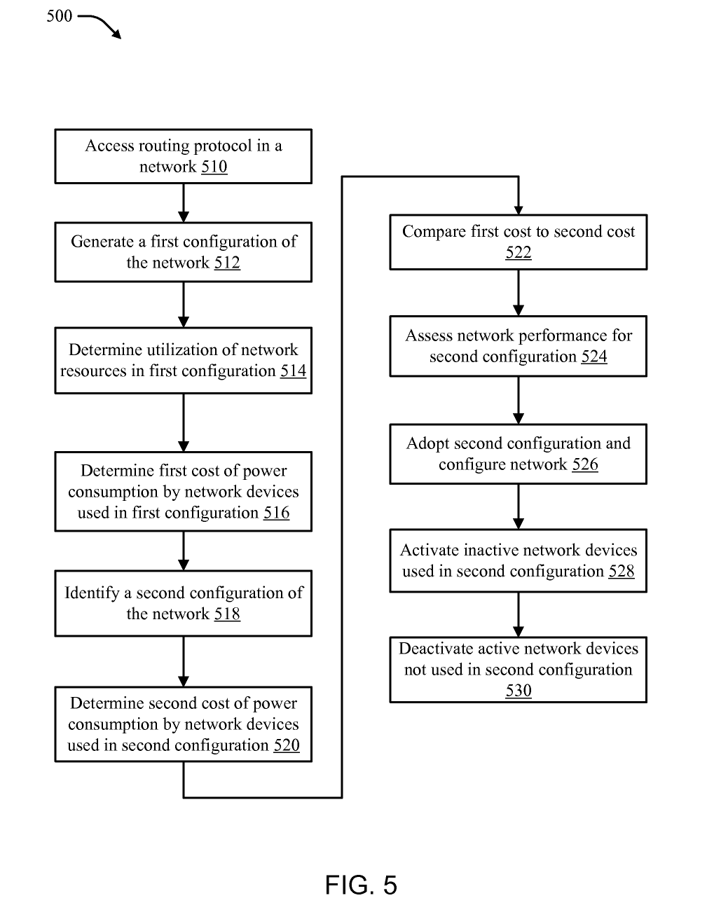

FIG. 5 is a flow chart illustrating an example of a process 500 for implementing power management in a network. The following describes process 500 as being performed by components of communications system 100 that is described with reference to FIG. 1. However, the process 500 may be performed by other communications systems or system configurations.

The process 500 may be used, for example, for collecting measurements on resource utilization by devices in a network and configuring network policies in the network for energy savings, taking into account the impact of the policies on the traffic routing in the network. Controller 120 that is tasked with configuring network policies in the communications system or network 100 accesses a routing protocol that is used for managing traffic in the network 100 (510). For example, controller 120 may gather information on the routing fabric in network 100 by running a routing engine that listens to the routing control traffic in the network 100 without actively forwarding packets. Based on the information gathered from the routing protocol, controller 120 may generate a first configuration of the network 100 (512). For example, controller 120 may develop the network topology by listening to the routing traffic in network 100 and thus be able to determine the present configuration in the network 100.

Controller 120 may determine the utilization of resources in the network 100 in the first configuration (514). For example, controller 120 may collect resource utilization data from the network devices 110a, 110b, 110c, 110d, 110e and 110f that are connected to controller 120 via LAN 170. Subsequently controller 120 may determine a first cost of power consumption by network devices used in the first configuration (516). For example, controller 120 may use the collected resource utilization data to compute measurements on the network resource utilization by the network devices 110a, 110b, 110c, 110d, 110e and 110f. Based on the computed measurements of the network resource utilization, the controller 120 may determine the power requirements for the network devices used in the present network topology. After determining the first cost, controller 120 may identify a second configuration of the network (518). For example, the controller 120 may access SLAs for applications that are using the network from the database 130 and historical data and trends from the database 140. Controller 120 may use the accessed SLAs and historical data and trends along with the computed resource requirements of the network devices 110a, 110b, 110c, 110d, 110e and 110f to generate network policies for the network 100 for specific time periods (e.g., time-of-day network policies). The generated network policies may recommend that the network configuration be modified to a new configuration to support the generated network policies.

Controller 120 may determine a second cost of power consumption by network devices used in the second configuration (520). For example, controller 120 may use the historical data and trends to compute the power requirements for the network devices that are to be used in the prospective new configuration to support the generated network policies. Controller 120 may compare the first cost to the second cost (522). For example, controller 120 may compare the power requirement for the prospective new configuration to the power requirement for the present configuration to determine the amount of energy savings.

Controller 120 may assess the network performance for the second configuration (524). For example, controller 120 may determine, using the routing engine that is operational in controller 120, the extent to which the traffic in the network 100 may be impacted if the prospective new configuration were adopted. For example, the controller 120 may use the routing engine to analyze the impact that would happen if a presently active network device is deactivated because the network device is not used in the prospective new configuration. The analysis may be performed by triggering an SPF routing update by removing a network device that is considered for hibernation based on the derived network policies. The controller 120 may analyze whether the updated routing topology is capable of supporting SLAs for critical traffic, and whether there are redundant paths in the network to handle link or node failure.

The controller 120 may adopt the second configuration and configure the network to support the second configuration (526). For example, the controller 120 may determine, based on the analysis of the impact of adopting the prospective new configuration, that the routing traffic is not adversely affected and that SLAs for important applications and network reliability requirements are satisfied. Therefore the controller 120 may decide to proceed with adopting the prospective new configuration.

Controller 120 may activate network devices used in the second configuration (528). For example, the controller 120 may communicate the generated network policies to each inactive network device that is to be activated to support the new configuration. Based on the received network policies, the hardware interfaces may be configured on each inactive network device so that it is operational in the network.

Controller 120 may deactivate network devices that are not used in the second configuration (530). For example, once all inactive network devices that are required in the new configuration are operational, controller 120 may determine whether the network traffic is being routed correctly through the network devices that are used in the new configuration. The controller 120 may be satisfied that the network traffic is being routed correctly. Therefore controller 120 may communicate the generated network policies to each active network device that is to be deactivated because it is not required in the new configuration. Consequently, the hardware interfaces may be configured to set the power levels on each active network device that is to be deactivated such that the network device is deactivated by entering a sleep state or hibernation state or by shutting down. Thus, the controller 120 may implement power management in network 100 by using process 500.

The disclosed and other examples can be implemented as one or more computer program products, i.e., one or more modules of computer program instructions encoded on a computer readable medium for execution by, or to control the operation of, data processing apparatus. The implementations can include single or distributed processing of algorithms. The computer readable medium can be a machine-readable storage device, a machine-readable storage substrate, a memory device, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In one configuration, the power consumption may be measured by an end device and/or by a proxy for the end device (e.g., a non-interruptible battery-powered backup system that serves as a hot standby). In another configuration, a proxy for the actual power consumed may be used. A proxy for the power consumed may include the number of active processors, the number of processes that are active, the number of tasks or queries that are performed or received, and/or the bandwidth consumed by the network traffic. For example, a network manager may determine that a specified query rate results in a specified computational burden, which in turn requires a specified number of processors and electrical power to support. Thus, a controller 120 comparing a first configuration to a second configuration may use a query rate (e.g., a number of HTTP requests seen by a load balancing device) as an indicator of the required power.

The projected power consumption and power savings may be configured to account for differences in the network devices used in a first configuration relative to a second configuration. The processors in a first location may be different than the processors in a second location. The controller 120 may be configured to account for differences in the capability of the processors in determining the various costs for a first and second configuration. A first configuration may involve the use of older processors that consume more power and/or yield lower performance than new processors that may represent more computationally powerful processors that operate at a different power setting.

The controller 120 may be configured to account for a granularity at which processes are being performed. For example, a more computationally complex processing task may involve a first level of power consumption while a less complex implementation may involve a second, lower, level of power consumption. As a controller 120 manages the instantiation of remote processes, the controller 120 may account for the granularity involved in using a first configuration at a first location relative to a second configuration at a second setting. Alternatively or in addition, the controller 120 may be configured to adjust a granularity setting (where possible) in order to realize additional efficiencies.

In one configuration, the transition from a first configuration to a second configuration is realized by configuring a controller 120 to adjust the routing metrics using by a routing protocol to establish routing tables. For example, a controller 120 could be configured to increase the routing cost of the link/device that is not present in the second computed topology. The effect of propagating changes to these routing costs for a specified link would be that other routers would start to avoid those resources. After a short period of time, these resources would not be used anymore and then it becomes safe to deactivate those resources.

The controller 120 may work in association with the routing protocol to interface with edge devices to realize reconfigurations. For example, a load balancing device that connects with a rack mounted array of blade processors may receive a routing update from the controller 120 and respond to the routing update by selectively activating and deactivating processors connected to the load balancer. The load balancing device may be configured to employ a “make-before-break” configuration to preclude an interruption of service during a transition from a first configuration to a second configuration. Likewise, routers and switches may be configured to maintain connectively and services so that interruptions do not arise during a transition from a first configuration to a second configuration.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer can include a processor for performing instructions and one or more memory devices for storing instructions and data. Generally, a computer can also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data can include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document may describe many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method for managing power consumption by network devices in a network, the method comprising:
accessing a routing protocol that manages an allocation of processing resources in the network;
generating a first configuration of a network using the routing protocol;
determining, for resources in the network, a utilization of the resources in the first configuration;
determining, based on the determined utilization of resources in the first configuration, a first cost that is indicative of power consumption of network devices associated with the first configuration;
identifying a second configuration, different from the first configuration, to support the utilization of the resources;
determining a second cost that is indicative of power consumption of network devices associated with the second configuration;
comparing the first cost to the second cost;
assessing prospective network performance assuming the second configuration was adopted;
deciding to adopt the second configuration based on results of comparing the first cost to the second cost and assessment of the prospective network performance;
configuring, based on the decision to adopt the second configuration, the network to use the second configuration; and
selectively activating processing resources on inactive network devices to support the second configuration and deactivating processing resources on active network devices being utilized in support of the first configuration that are not utilized in support of the second configuration.

2. The method of claim 1, further comprising:
in response to selectively activating processing resources on inactive network devices to support the second configuration, determining whether network performance is satisfied using network devices activated to support the second configuration; and
based on a determination that network performance is satisfied using network devices activated to support the second configuration, selectively deactivating processing resources on active network devices utilized in support of the first configuration that are not utilized in support of the second configuration.

3. The method of claim 1, wherein the deactivating processing resources on active network devices being utilized in support of the first configuration is performed in a non-disruptive manner such that the network traffic that was being transmitted using the first configuration is not affected.

4. The method of claim 1 wherein determining the second cost reflects a power impact in a second location used in the second configuration that is different than the power impact for the first cost at a first location different from the second location.

5. The method of claim 1 wherein determining the second cost reflects a second time that is different than the first cost for a first time.

6. The method of claim 1 wherein the resources are selected from a group including power consumption per server, CPU capacity/utilization, memory utilization, disk utilization, traffic utilization in terms of packets per second, link capacity, link utilization, interface capacity and interface utilization.

7. The method of claim 1 further comprising:
measuring, for a device in the network, environmental parameters including physical location of the network device in a row or a rack, ambient temperature of the network device, ambient temperature of a rack including the network device, ambient temperature of a server including the network device, humidity and heat dissipation; and
using the environmental parameter to determine the first cost.

8. The method of claim 1 wherein configuring the network to use the second configuration includes configuring the routing protocol to develop a routing topology based on the first cost and the second cost.

9. The method of claim 1 wherein determining the impact of power consumption of network devices used in the second configuration includes accessing historical data associated with power consumption of network devices used in the second configuration.

10. The method of claim 1 wherein selectively activating the processing resources and deactivating the processing resources includes configuring a load balancer in the network to distribute a load among a collection of the processing resources.

11. The method of claim 1 wherein identifying the second configuration includes identifying an impact on routing due to the second configuration.

12. The method of claim 11 wherein identifying the impact on routing is based on one or more service level agreements (SLA) used for the routing.

13. A method for managing resource utilization of network devices in a network, the method comprising:
assessing a resource utilization characteristic of an existing network configuration;
assessing a resource utilization characteristic expected of a prospective network configuration if adopted;
comparing the resource utilization characteristic of the existing network configuration to the resource utilization characteristic of the prospective network configuration;
assessing a performance characteristic of the prospective network configuration;
adopting the prospective network configuration only if the comparison of the resource utilization characteristic and assessment of the performance characteristic yield results indicating improvement in resource utilization and performance upon adopting the prospective network configuration.

14. The method of claim 13, wherein the assessment of the performance characteristic is undertaken only if the comparison of the resource utilization characteristic yields a result favorable to adopting the prospective configuration.

15. A apparatus for managing power consumption by network devices in a network, the apparatus comprising:
a computer processor including one or more instructions that when executed by the computer processor are operable to:
access a routing protocol that manages an allocation of processing resources in the network; generate a first configuration of a network using the routing protocol;
determine, for resources in the network, a utilization of the resources in the first configuration;
determine, based on the determined utilization of resources in the first configuration, a first cost that is indicative of power consumption of network devices associated with the first configuration;
identify a second configuration, different from the first configuration, to support the utilization of the resources;
determine a second cost that is indicative of power consumption of network devices associated with the second configuration;
compare the first cost to the second cost;
assess prospective network performance assuming the second configuration was adopted;
decide to adopt the second configuration based on results of comparing the first cost to the second cost and assessment of the prospective network performance;
configure, based on the decision to adopt the second configuration, the network to use the second configuration; and
selectively activate processing resources on inactive network devices to support the second configuration and deactivate processing resources on active network devices being utilized in support of the first configuration that are not utilized in support of the second configuration.

16. The computer processor of claim 15, further comprising one or more instructions that when executed by the computer processor are operable to:
in response to selectively activating processing resources on inactive network devices to support the second configuration, determine whether network performance is satisfied using network devices activated to support the second configuration; and
based on a determination that network performance is satisfied using network devices activated to support the second configuration, selectively deactivate processing resources on active network devices utilized in support of the first configuration that are not utilized in support of the second configuration.

17. A non-transitory computer-readable storage medium including instructions executable by one or more computer processors, the non-transitory computer-readable storage medium comprising instructions for causing the one or more computer processors to perform operations comprising:
accessing a routing protocol that manages an allocation of processing resources in the network;
generating a first configuration of a network using the routing protocol;
determining, for resources in the network, a utilization of the resources in the first configuration;
determining, based on the determined utilization of resources in the first configuration, a first cost that is indicative of power consumption of network devices associated with the first configuration;
identifying a second configuration, different from the first configuration, to support the utilization of the resources;
determining a second cost that is indicative of power consumption of network devices associated with the second configuration;
comparing the first cost to the second cost;
assessing prospective network performance assuming the second configuration was adopted;
deciding to adopt the second configuration based on results of comparing the first cost to the second cost and assessment of the prospective network performance;
configuring, based on the decision to adopt the second configuration, the network to use the second configuration; and
selectively activating processing resources on inactive network devices to support the second configuration and deactivating processing resources on active network devices being utilized in support of the first configuration that are not utilized in support of the second configuration.

18. The computer-readable storage medium of claim 17, further comprising one or more instructions for:
in response to selectively activating processing resources on inactive network devices to support the second configuration, determining whether network performance is satisfied using network devices activated to support the second configuration; and
based on a determination that network performance is satisfied using network devices activated to support the second configuration, selectively deactivating processing resources on active network devices utilized in support of the first configuration that are not utilized in support of the second configuration.

19. The computer-readable storage medium of claim 17, wherein determining the second cost reflects a power impact in a second location used in the second configuration that is different than the power impact for the first cost at a first location different from the second location.

20. The computer-readable storage medium of claim 17, wherein determining the second cost reflects a second time that is different than the first cost for a first time.

21. The computer-readable storage medium of claim 17, further comprising one or more instructions for:
measuring, for a device in the network, environmental parameters including physical location of the network device in a row or a rack, ambient temperature of the network device, ambient temperature of a rack including the network device, ambient temperature of a server including the network device, humidity and heat dissipation; and
using the environmental parameter to determine the first cost.

22. The computer-readable storage medium of claim 17, wherein configuring the network to use the second configuration includes configuring the routing protocol to develop a routing topology based on the first cost and the second cost.

23. The computer-readable storage medium of claim 17, wherein determining the impact of power consumption of network devices used in the second configuration includes accessing historical data associated with power consumption of network devices used in the second configuration.

24. The computer-readable storage medium of claim 17, wherein selectively activating the processing resources and deactivating the processing resources includes configuring a load balancer in the network to distribute a load among a collection of the processing resources.

25. The computer-readable storage medium of claim 17, wherein identifying the second configuration includes identifying an impact on routing due to the second configuration.

26. The computer-readable storage medium of claim 25, wherein identifying the impact on routing is based on one or more service level agreements (SLA) used for the routing.
